(19) United States
(12) Patent Application Publication
(10) Pub. No.: US 2016/0212055 A1
(43) Pub. Date: Jul. 21, 2016

(54) HOST-BASED LOAD BALANCING OF NETWORK TRAFFIC

(71) Applicant: International Business Machines Corporation, Armonk, NY (US)

(72) Inventors: KANAK B. AGARWAL, Austin, TX (US); John B. Carter, Austin, TX (US); Wesley M. Felter, Austin, TX (US); Keqiang He, Madison, WI (US); Eric J. Rozner, Austin, TX (US)

(73) Assignee: International Business Machines Corporation, Armonk, NY (US)

(21) Appl. No.: 14/601,556

(22) Filed: Jan. 21, 2015

(51) Int. Cl. H04L 12/805; H04L 12/803; H04L 12/801

(52) U.S. Cl. CPC H04L 47/365; H04L 47/196; H04L 47/125

(57) ABSTRACT

At an application at a sender system, when an amount of data to be transmitted from the sender exceeds a flow size threshold, the data is divided into a set of chunks of a size. According to a mapping selection rule, a subset is selected from a set of selected label mappings, wherein each label mapping in the subset maps an original label in the data to a different virtual label. For a chunk, when by routing the chunk to a first networking component corresponding to a first virtual label a fraction of the amount of data that will have been routed to the first component will exceed a mapping threshold, the original label in the chunk is replaced with a second virtual label from a second label mapping in the subset. The chunk is routed to a second networking component corresponding to the second virtual label.

### TECHNICAL FIELD

The present invention relates generally to a method, system, and computer program product for managing data traffic in a data network. More particularly, the present invention relates to a method, system, and computer program product for host-based load balancing of network traffic.

### BACKGROUND

A data network facilitates data transfers between two or more data processing systems. For example, an application executing in one data processing system acts as the sender of the data, and another application executing in another data processing system acts as the receiver of the data. Between the sender system (also referred to herein as “host” or “sender node”) and the receiver system (also referred to herein as “receiver node”), the data follows a data path that comprises one or more links between networking components, such as routers and switches.

Within a data processing system, such as in the sender system, the sender application typically hands-off the data to some functionality in the system that manages the data flows in and out of the system. A hypervisor is an example of such functionality.

A hypervisor facilitates the sharing of all or some of the resources available in a host system amongst one or more virtualized data processing systems configured on the host system. The shared resources can be hardware, software, or firmware available in the host system. Some examples of host system resources shared using a hypervisor include, but are not limited to, a processor, a memory, a network adapter, a storage device, an operating system component, a firmware component, and a bus.

For example, for sending or flowing data out of the sender system, a sender application hands of the data to a virtual switch executing in the hypervisor. The virtual switch sends the data to a Transmission Control Protocol (TCP) stack, and the data eventually leaves the sender system via a physical Ethernet adapter configured in the system. Once the data leaves the sender system, the data travels on one or more data communication links to one or more networking components, and eventually reaches the receiver application.

In a data processing environment, such as in a datacenter, many data processing systems are connected via a data network. At any given time, several systems may be transmitting data of various sizes to several other systems. Many of these data transmissions can utilize a common link in the network, to get from their respective sender systems to their respective receiver systems.

A data communication link in a network can become congested when more than a threshold amount of data traffic tries to use the link during a given period. The data traffic of some data flows (hereinafter, “flow”, or “flows”) appears in bursts, causing the data traffic on a link to spike. A link can also be over-subscribed, i.e., too many flows may try to use the link at a given time. Flow collisions, packet loss, network latency, and timeouts are some examples of problems that are caused when the utilization of a link exceeds a threshold.

Some flows in a network are small flows and some are large flows. A flow that transmits less than a threshold amount of data in a given period is a small flow. A flow that transmits the threshold amount of data or more in a given period is a large flow.

The data of the various flows wanting to use a link are queued. For using a link, a small flow that is queued after a large flow will have to wait significantly longer to use the link, as compared to when the small flow is queued after another small flow. Typically, over a period of operation in a data network, small flows outnumber large flows but data transmitted by large flows exceeds the data transmitted by small flows. Thus, the use of communication links in a network by a mix of large and small flows often results in unacceptable performance of applications and operations related to the small flows, because of the large flows.

### SUMMARY

The illustrative embodiments provide a method, system, and computer program product for host-based load balancing of network traffic. An embodiment includes a method for host-based load balancing of network traffic. The embodiment determines, at an application executing at a sender data processing system, whether an amount of data to be transmitted from the sender data processing system exceeds a flow size threshold. The embodiment divides, responsive to the amount of data exceeding the flow size threshold, the data into a set of chunks, each chunk in the set of chunks being of a chunk size. The embodiment selects, according to a mapping selection rule, from a set of selected label mappings, a subset of selected label mapping, wherein each label mapping in the subset of selected label mappings maps an original label used in the data to a different virtual label according to the label mapping. The embodiment evaluates, at the application, for a first chunk in the set of chunks, whether by routing the first chunk to a first networking component corresponding to a first virtual label from a first label mapping in the subset of selected label mappings, a fraction of the amount of data that will have been routed to the first component will exceed a mapping threshold. The embodiment replaces, responsive to the evaluating being affirmative, the original label in first chunk with a second virtual label from a second label mapping in the subset of selected label mappings. The embodiment routes the first chunk to a second networking component corresponding to the second virtual label at the time of the routing.

Another embodiment includes a computer usable program product comprising a computer readable storage device including computer usable code for host-based load balancing of network traffic

Another embodiment includes a data processing system for host-based load balancing of network traffic. The embodiment further includes a storage device, wherein the storage device stores computer usable program code. The embodiment further includes a processor, wherein the processor executes the computer usable program code.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for host-based load balancing of network traffic in accordance with an illustrative embodiment;

FIG. 4 depicts a block diagram of an example configuration of an application for host-based load balancing of network traffic in accordance with an illustrative embodiment;

FIG. 5 depicts a block diagram of an additional configuration of an application for host-based load balancing of network traffic in accordance with an illustrative embodiment;

FIG. 6 depicts a flowchart of an example process for configuring a sender system for host-based load balancing of network traffic in accordance with an illustrative embodiment; and

FIG. 7 depicts a flowchart of an example process for host-based load balancing of network traffic in accordance with an illustrative embodiment.

### DETAILED DESCRIPTION

Load balancing across communication links in a data network is performed in several ways. For example, one presently used method for load balancing uses the 5-tuple (source address, destination address, source port, destination port, protocol) in the data packets of a flow to direct the flows to certain links in the network. The method hashes the 5-tuple to obtain a hash value. Because all data packets in a flow from the same sender to the same receiver will have identical 5-tuples, the hash values of the 5-tuples of all data packets in a given flow will match with one another, but not with the hash value of the 5-tuples of the data packets of a different flow. Whether a particular implementation of this method uses these five fields or other fields for the hashing, this method routes the packets at a flow-level, not at a sub-flow or chunk level as described herein.

According to this method, all packets whose hashed 5-tuple match one hash value are routed to one link and all packets whose hashed 5-tuple match another hash value are routed to a different link. This method requires custom functionality to be built into the networking components in the network to perform the hashing and hash-based routing of flows. Even if such functionality has become available in switches and other networking components, this functionality has to be configured, updated, and managed in remote networking components and cannot be managed at the sender data processing system. Furthermore, another problem with this approach is that two large flows can get hashed to the same link, resulting in congestion on the link, which can lead to increased latencies for small flows.

Another presently used method, such as Multi-Path TCP (MPTCP), modifies the TCP stack in a networking component such that the modified TCP stack distributes a flow over more than one links in the network. This method requires modification of the TCP stack, which is often not possible or available in a particular networking component.

The illustrative embodiments recognize that presently available methods for load balancing across communication links require either special networking equipment, or customization to networking components. The illustrative embodiments recognize that configuring and managing the custom equipment, which is typically located remotely into the network relative to the sender and receiver data processing systems is expensive, problematic, and error-prone.

The illustrative embodiments used to describe the invention generally address and solve the above-described problems and other problems related to managing data traffic in communication links in a network. The illustrative embodiments provide a method, system, and computer program product for host-based load balancing of network traffic.

A label is an identifier that is unique in a network. Within the scope of the illustrative embodiments, a label, for example, a virtual label, need not necessarily be assigned to a data processing system, device, equipment, component, or application. A media access control (MAC) address is an example of a label that is associated with some hardware. Within the scope of the illustrative embodiments, a virtual MAC address can be created such that the virtual MAC address is not associated with any particular hardware or software.

A label can be associated with a flow or a portion of a flow. For example, a data packet in a flow can have a label, e.g., a MAC address of a destination network adapter, where the destination network adapter is the receiver of the data packet.

An embodiment executes as an application at a sender data processing system from which a flow originates. For example, one embodiment is configured as software instructions that execute in, or in conjunction with a virtual switch in a hypervisor at a sender data processing system. Another embodiment is configured as software instructions, which execute in another application at a sender data processing system, which receives data from a sender application, and which hands off the data to a TCP stack or an equivalent structure. Only for the clarity of the description and without implying any limitation thereto, the example implementation of a virtual switch in a hypervisor is used as an example scenario to describe certain operations and functions of the various embodiments.

An embodiment creates a set of fragments of data from a flow. Each fragment is called a chunk and each chunk is less than or equal to a chunk size threshold. For example, if a large flow were 1024 Kilo Bytes (KB) in size, the embodiment creates chunks from the large flow such that no chunk is larger than 1500 Bytes in size, thereby creating 683 chunks.

An embodiment can be adapted to configure the chunk size in a variety of ways. For example, one embodiment sets a chunk size threshold for a period for all of some flows, such that no chunk of those flows can exceed that chunk size threshold during that period.

Another embodiment sets a chunk time threshold. A chunk time threshold is an amount of data measured by the length of time during which that data is received for transmission. For example, a chunk time threshold of 10 milliseconds means a chunk can only include that amount of data which can be received in 10 milliseconds or less by the embodiment for transmission.

Another embodiment sets a flowlet-based chunk size. A flowlet-based chunk size is an amount of data received in a predetermined number of bursts for transmission. For example, a flowlet threshold of 1 means a chunk can only include that amount of data which is received in 1 burst, by the embodiment for transmission.

These example manners of configuring a chunk size are not intended to be limiting on the illustrative embodiments. Other suitable ways of configuring flow chunking will be apparent from this disclosure to those of ordinary skill in the art and the same are contemplated within the scope of the illustrative embodiments. Furthermore, an embodiment can be configured such that the embodiment chunks only large flows and not the small flows.

Each chunk of a flow has a label associated with the chunk. The label of a chunk is originally the label associated with the flow from which the chunks are created.

An embodiment creates a set of virtual labels. A virtual label in the set of virtual labels is not fixedly assigned to any particular hardware or software component operating in the network. During the operation of the network, different virtual labels correspond to different networking components to which a chunk of a flow can be routed. The correspondence between a virtual label and a networking component can change, and the same virtual label can correspond to different networking components at different times.

Furthermore, not all virtual labels may correspond to networking components at a given time. For example virtual label VL1 may correspond to component C1 at a given time but virtual label VL5 may not correspond to any component at the given time.

Some virtual labels may not correspond to a functional networking component. For example, when virtual label VL1 is set to correspond to component C1, and C1 is inoperational, unavailable, or otherwise configured to not participate in a flow in a network, VL1 does not correspond to a functional networking component.

A label received in a flow from a sender application is called an original label. An embodiment creates a set of mappings between an original label and a subset of the set of virtual labels. Each mapping in a set of mappings of an original label comprises the original label and a member of the subset of virtual labels.

A mapping selection rule selects, for a given original label, one or more mappings from the set of mappings of the given original label. For example, suppose that an original label L1 in a flow has four mappings to VL1, VL2, VL3, and VL4. Suppose that an example condition in an example mapping selection rule specifies that only those mappings should be selected whose virtual labels correspond to available components in the network at the time when the rule is executed. Further assume that at the time of execution of the rule, VL2 does not correspond to any operational component in the network that can receive the flow or a chunk thereof. Accordingly, the example mapping selection rule determines that only the mappings L1-VL1, L1-VL3, and L1-VL4 are to be selected.

The example rule and the example condition are not intended to be limiting on the illustrative embodiments. From this disclosure, those of ordinary skill in the art will be able to conceive many other selection criteria for configuring other mapping selection rules and the same are contemplated within the scope of the illustrative embodiments.

Using the selected mappings, an embodiment replaces an original label in a chunk with a mapped virtual label from one of the selected mappings. A label is usable to direct the chunk to a networking component. Where the original label was usable to direct the chunk to the receiver system, replacing the original label with a virtual label causes an embodiment to route the chunk to the component corresponding to the virtual label.

In order to determine which mapping from the selected mappings to use for the replacement operation, the embodiment tracks an amount of data sent from the flow to the component corresponding to the various virtual labels of the selected mappings. If by sending a present chunk to a component corresponding to a various virtual label will cause the amount of data sent from the flow to the component to exceed a mapping threshold, the embodiment selects a different mapping for the replacement operation and sends the present chunk to the another component.

Consider, for example, that the chunk size is 1500 Bytes and the mapping threshold is 64 KB, to wit, only 64 KB of data from a flow can be sent during a period to a component that is associated with a virtual label in any selected mapping. Chunks are streamed as they are formed and transformed by an embodiment, and chunks do not wait to be grouped together for sending. Assume that mappings L1-VL1, L1-VL3, and L1-VL4 are selected, and the component C1 corresponding to VL1 has received 42 chunks that have already been streamed in a specified period. Accordingly, the embodiment determines that sending the present chunk as a 43^{rd} chunk to C1 will exceed the mapping threshold, and therefore does not select VL1 to replace L1 in the present chunk. The embodiment selects VL3 as a replacement for L1 in the present chunk and streams the present chunk to component C3 corresponding to VL3.

Sending chunks to C1 until the mapping threshold would be reached and then switching to C3 is only an example manner of replacing the original labels in the chunks. Other manners of selecting one of the selected mappings for determining a suitable virtual label that should replace the original label in a given chunk are contemplated within the scope of the illustrative embodiments. For example, an embodiment can be adapted to send one chunk at a time to each of the available components corresponding to the virtual labels in the selected mappings, e.g., in a round-robin fashion, unless sending a chunk to a particular component would cause the mapping threshold to be exceeded for that component. As another example, an embodiment can be adapted to send a chunk to that available component corresponding to a virtual label, which has received the least amount of data in the given period.

As another example, an embodiment can be adapted to assign weights to each virtual label depending on any number of factors. Some examples of the weighting factors include but are not limited to current traffic volume at the component associated with the virtual label, topological constraints associated with reaching that component, and the like. The weights of the various virtual labels could change as network conditions change. Accordingly, one example embodiment selects the virtual label with the highest weight at any given time as the replacement for a label. Another embodiment selects a virtual label using some function of the weights, instead of always picking the virtual label with the highest weight.

A method of an embodiment described herein, when implemented to execute on a device or data processing system, comprises substantial advancement of the functionality of that device or data processing system in load balancing across network links. For example, in order to load balance across network links, the prior-art requires customized components that are situated away from the sender or receiver systems in the network, or require modifications to the TCP stack in the sender system. In contrast, an embodiment modifies the flow, particularly a large flow, prior to the TCP stack in the sender system receiving the data of the flow, such that when the TCP stack receives the data of the flow, the chunks of the flow are already configured to use different links to different available components in the network. Such manner of host-based load balancing of network traffic, which is transparent to the sender application, transparent to the TCP stack, and requires no modification or customization of networking components, is unavailable in presently available devices or data processing systems. Thus, a substantial advancement of such devices or data processing systems by executing a method of an embodiment facilitates the load balancing of network traffic even before the data of a flow leaves the sender system.

The illustrative embodiments are described with respect to certain flows, protocols, sizes, thresholds, labels, networking components, mappings, rules, selections, manners of replacements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

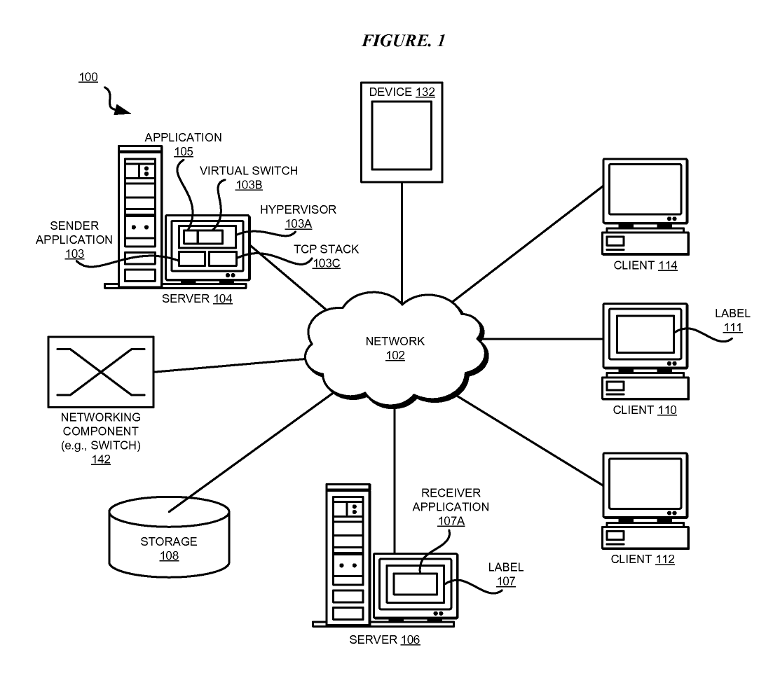

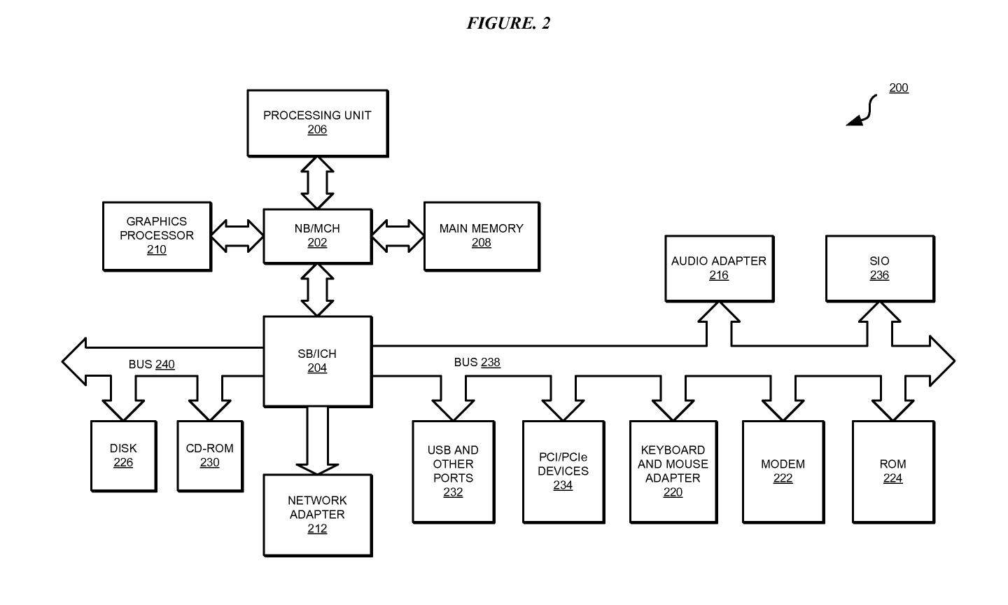

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner. Server 104 operates as a sender system and executes sender application 103 thereon. Hypervisor 103A is configured in server 104. Virtual switch 103B executes in hypervisor 103A. Application 105 implements an embodiment described herein. Virtual switch 103B is modified to operate in conjunction with application 105 to perform the operations according to an embodiment described herein. In one configuration, some aspects of an embodiment are implemented in application 105 and some aspects of the embodiment are implemented as modifications to virtual switch 103B. Label 111 is associated with client 110. For example, label 111 may be an original label, and client 110 may be a receiver system as described herein. Similarly, label 107 may be an original label, and server 106 may be a receiver system as described herein. Example networking component 142 may be a switch, a router, or another type of networking component in network 102, and may correspond to a virtual label (not shown) during a given period, as described herein. Assume an example large flow from sender application 103 to a receiver application 107A in server 107. The combination of application 105 and virtual switch 103B perform chunking of the data of the large flow, replace the label in a chunk with a virtual label, and hand off the chunk with the virtual label to TCP stack 103C. Hypervisor 103A and virtual switch 103B therein operate in conjunction with TCP stack 103C, and use the replaced virtual label in the chunk to cause the chunk to be sent to networking component 142 instead of a receiver system, e.g., instead of server 107.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), Linux® (Linux is a trademark of Linus Torvalds in the United States and other countries), iOS™ (iOS is a trademark of Cisco Systems, Inc. licensed to Apple Inc. in the United States and in other countries), or Android™ (Android is a trademark of Google Inc., in the United States and in other countries). An object oriented programming system, such as the Java™ programming system, may run in conjunction with the operating system and provide calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as virtual switch 103B and application 105 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a mobile computing device, which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

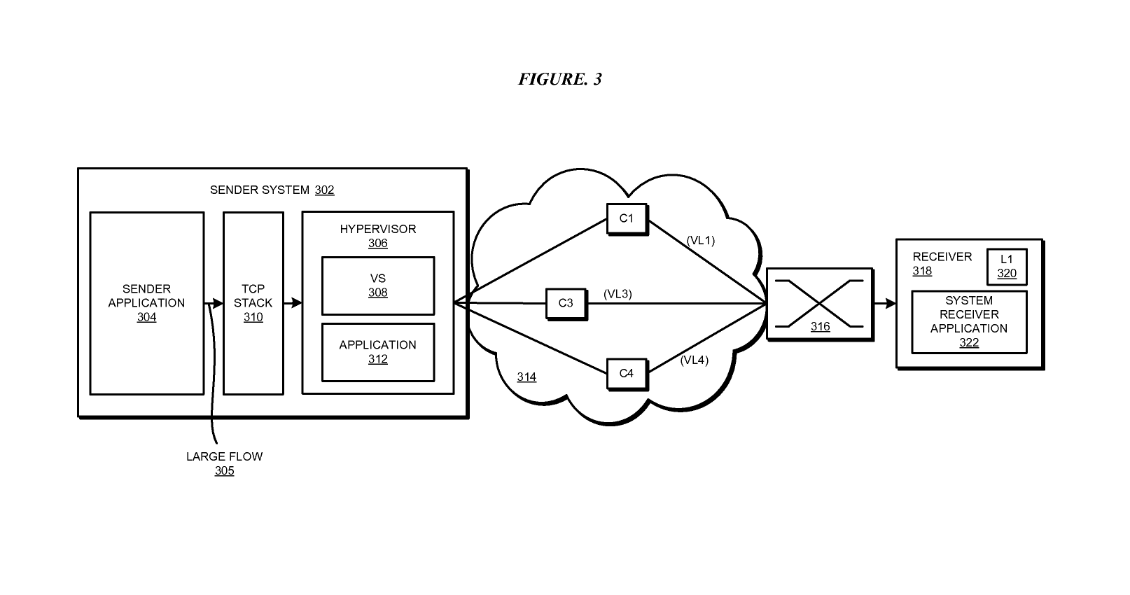

With reference to FIG. 3, this figure depicts a block diagram of an example configuration for host-based load balancing of network traffic in accordance with an illustrative embodiment. Sender system 302 is an example of server 104, sender application 304 is an example of sender application 103, hypervisor 306 is an example of hypervisor 103A, virtual switch 308 is an example of virtual switch 103B, and TCP stack 310 is an example of TCP stack 103C, respectively, in FIG. 1. Application 312 can be implemented as application 105 in FIG. 1.

Sender application 304 prepares large flow 305 to send over network 314 to receiver component 316 associated with receiver system 318. Large flow 305 uses label 320 as an original label to cause the data of large flow 305 to reach receiver application 322 in receiver system 318 via receiver component 316.

Hypervisor 306, or another similarly purposed application in a given implementation, receives large flow 305 from sender application 304. Virtual switch 308, or another similarly purposed application in a given implementation, operating in conjunction with application 312 creates a set of chunks from large flow 305.

For example, application 312 provides to virtual switch 308 the configured flow size threshold to determine whether a flow qualifies as a large flow. Using the flow size threshold, virtual switch 308 detects or determines that flow 305 received from sender application 304 qualifies as a large flow. Similarly, application 312 provides the configured chunk size threshold to virtual switch 308, which virtual switch 308 uses to create a set of chunks from large flow 305.

Application 312 maintains a set of mappings for the original labels that are possible in the flows received by hypervisor 306, such as from sender application 304 and other such applications executing in sender system 302. The set of mappings map such original labels to virtual labels in a set of virtual labels. Note that an original label can be mapped to one or more virtual labels, and one or more original labels can be mapped to a particular virtual label.

Virtual switch 308 operating in conjunction with application 312 selects one or more mappings applicable to the original label in the chunks of large flow 305. For example, virtual switch 308 uses a mapping selection rule, from a set of mapping selection rules that application 312 maintains, to select one or more mappings applicable to the original label of the chunks.

Virtual switch 308 performs flow management of large flow 305 over network 314. Particularly, in the flow management operation, virtual switch 308 determines whether a mapping threshold has been reached or will be exceeded for a component in network 314 if the original label in a chunk of large flow 305 is replaced using the virtual label presently associated with the component. If this determination is affirmative, virtual switch 308 selects a different mapping and thereby a different virtual label to replace the original label of the chunk. If the determination is negative, virtual switch 308 replaces the original label of the chunk with the virtual label associated with the component.

Recall the example described above where for original label L1 (320), mappings L1-VL1, L1-VL3, and L1-VL4 are selected. Component C1 in network 314 corresponds to virtual label VL1, component C3 in network 314 corresponds to virtual label VL3, and component C4 in network 314 corresponds to virtual label VL4. Suppose that some chunks of large flow 305 have already had their original label L1 replaced with virtual label VL1, and those chunks been routed to C1. Virtual switch 308 determines that if L1 is replaced with VL1 in a present chunk, the mapping threshold will be exceeded for C1. Therefore, virtual switch 308 replaces L1 in the present chunk with VL3 (or VL4), causing the present chunk to be routed to C3 (or C4 correspondingly). Various chunks of large flow 305 are routed to C1, C3, and C4 during a given period depending upon similar determinations and label replacements by the combination of application 312 and virtual switch 308.

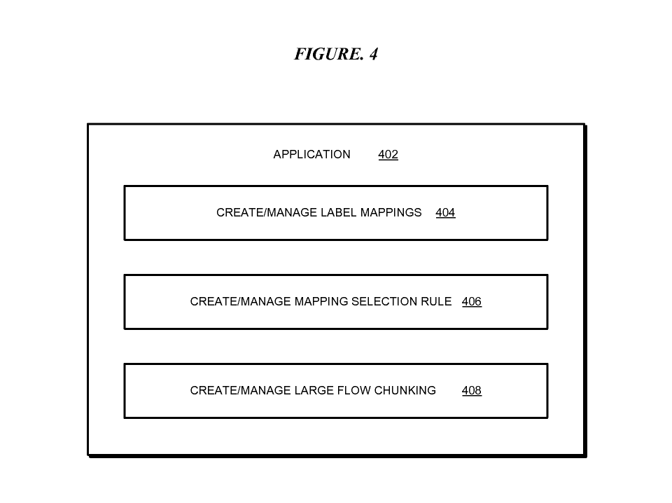

With reference to FIG. 4, this figure depicts a block diagram of an example configuration of an application for host-based load balancing of network traffic in accordance with an illustrative embodiment. Application 402 can be implemented as application 312 in FIG. 3. In one embodiment, application 402 may execute as a separate or second instance of application 312 in the configuration of FIG. 3.

Component 404 operates to create, add, delete, modify, or otherwise manage a label mapping. For example, in one embodiment, component 404 presents a user interface, using which a user can manipulate a set of virtual labels to use in label mappings, manipulate a mapping between an original label and a virtual label, or both. In another embodiment, component 404 automatically discovers the original labels in use at a sender system, available components in the network at a given time, or both. Component 404 then manipulates the correspondence between a virtual label and a component, manipulates a mapping between an original label and a virtual label, or both.

Component 406 operates to create, add, delete, modify, or otherwise manage a label mapping selection rule. For example, in one embodiment, component 406 presents a user interface, using which a user can manipulate a set of label mapping rules. In another embodiment, component 406 automatically configures a mapping selection rule according to a specification.

Component 408 operates to create, add, delete, modify, or otherwise manage one or more sizes, manners of determining the sizes, thresholds, manners of operating without violating a threshold, or a combination thereof. For example, in one embodiment, component 408 presents a user interface, using which a user can configure a chunk size, a manner of determining a chunk size, a flow size threshold, a mapping threshold, a manner of routing chunks of large flows without violating the mapping threshold, other configurable parameters described herein, or some combination thereof. In another embodiment, component 408 automatically configures or manipulates these and other configurable parameters described in this disclosure.

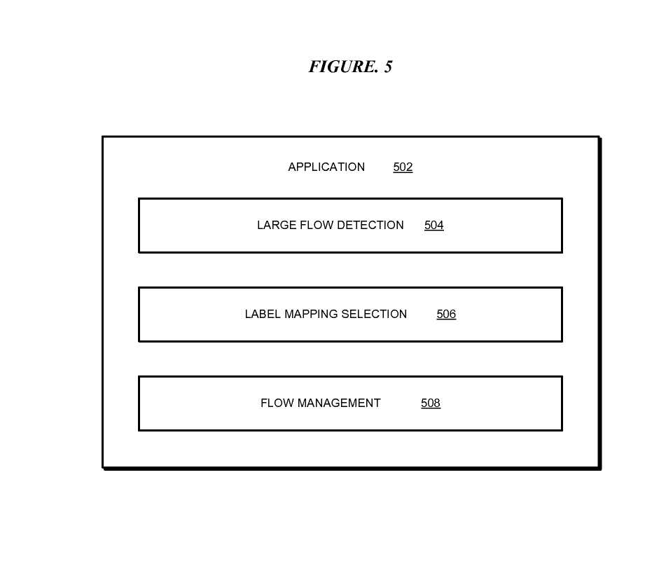

With reference to FIG. 5, this figure depicts a block diagram of an additional configuration of an application for host-based load balancing of network traffic in accordance with an illustrative embodiment. Application 502 can be implemented as application 312 in FIG. 3, or in virtual switch 308 in FIG. 3. In one embodiment, application 402 of FIG. 4 and application 502 may execute as separate instance of application 312 in the configuration of FIG. 3.

Component 504 operates to determine whether a flow from a sender application qualifies as a large flow. For a flow that qualifies as a large flow, such as large flow 305 in FIG. 3, component 504 operates to create a set of chunks of the large flow.

Component 506 operates to select a suitable label mapping for replacing an original label in a chunk created by component 504. For example, component 506 executes one or more mapping selection rules to select a subset of a set of mappings applicable to a given original label during any given period. Component 506 may change the selections in the subset during different periods, due to changing network conditions, or a combination of these and other factors.

Component 508 performs the flow management function described elsewhere in this disclosure. For example, component 508 tracks the amount of data sent in chunks to components corresponding to the various mapped virtual labels. Depending upon whether sending a chunk to a component corresponding to a particular virtual label would violate the mapping threshold, component 508 performs the label replacements in the chunks created by component 504 using the subset of the label mappings selected by component 506.

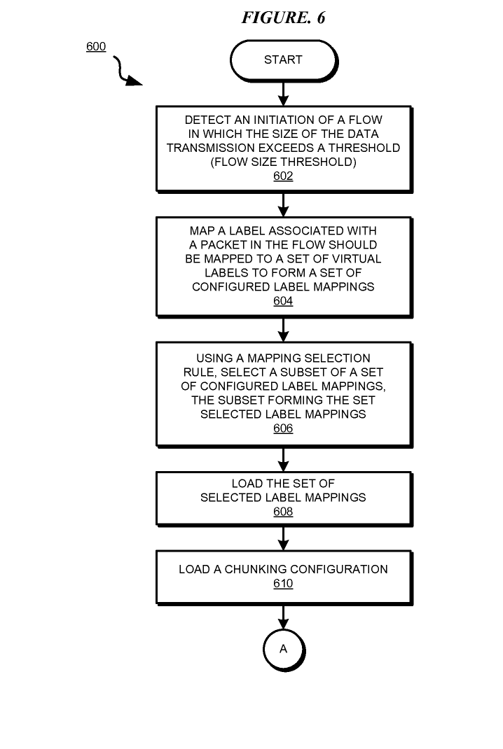

With reference to FIG. 6, this figure depicts a flowchart of an example process for configuring a sender system for host-based load balancing of network traffic in accordance with an illustrative embodiment. Process 600 can be implemented in application 402 of FIG. 4, application 502 of FIG. 5, or a combination thereof, depending upon the particular implementation.

The application detects an initiation of a flow in which the size of the data transmission exceeds a flow size threshold (block 602). The application maps a label associated with a packet in the flow to a set of virtual labels, forming a set of configured label mappings (block 604).

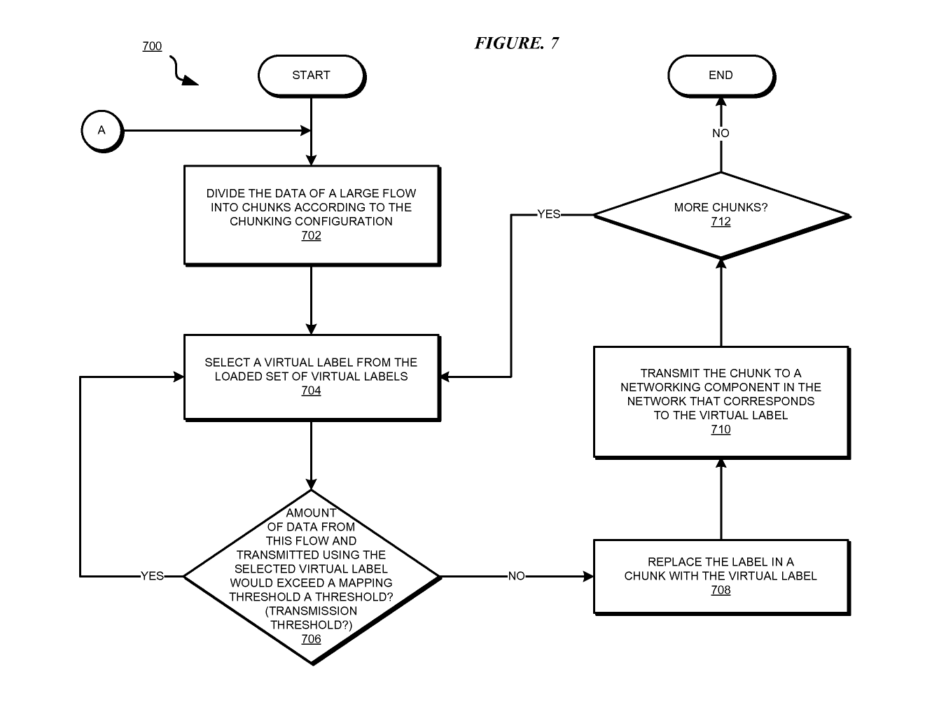

Using a mapping selection rule, the application selects a subset of the set of configured label mappings, the subset forming a set of selected label mappings (block 606). The application loads the set of selected label mappings (block 608). The application loads a set of configured parameters for creating and routing chunks of the large flow (block 610). The application then exits process 600 at exit point marked “A”, to enter process 700 in FIG. 7 at entry point marked “A”.

With reference to FIG. 7, this figure depicts a flowchart of an example process for host-based load balancing of network traffic in accordance with an illustrative embodiment. Process 700 can be implemented in application 402 of FIG. 4, application 502 of FIG. 5, or a combination thereof, depending upon the particular implementation.

The application divides the data of a large flow into a set of chunks according to a parameter, such as a chunk size threshold, a chunk time threshold, a flowlet threshold, or other similarly purposed parameter, loaded in block 610 in FIG. 6 (block 702). For a chunk from the set, the application selects a virtual label from the set of selected label mappings loaded in block 608 in FIG. 6 (block 704).

The application determines whether sending another chunk using the selected virtual label would cause the amount of data from this flow transmitted during a period using the selected virtual label to exceed a mapping threshold (block 706). Note that the mapping threshold can be defined in any suitable manner, and can even change in a dynamic manner depending upon network conditions, such as according to a changeable weight assigned to the virtual label.

If sending the chunk would cause the mapping threshold to be exceeded (“Yes” path of block 706), the application returns process 700 to block 704, to select another virtual label from another label mappings. If sending the chunk would not cause the mapping threshold to be exceeded (“No” path of block 706), the application replaces the original label in the chunk with the selected virtual label (block 708).

The application transmits the chunk to a networking component that corresponds to the virtual label (block 710). The application determines if more chunks from the large flow are to be processed in a similar manner (block 712). If more chunks remain to be processed (“Yes” path of block 712), the application returns process 700 to block 704 and begin the process from block 704 for another chunk. If no more chunks remain to be processed from the large flow (“No” path of block 712), the application ends process 700 thereafter.

Thus, a computer implemented method, system or apparatus, and computer program product are provided in the illustrative embodiments for host-based load balancing of network traffic. Where an embodiment or a portion thereof is described with respect to a type of device, the computer implemented method, system or apparatus, the computer program product, or a portion thereof, are adapted or configured for use with a suitable and comparable manifestation of that type of device.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for host-based load balancing of network traffic, the method comprising:
determining, at an application executing at a sender data processing system, whether an amount of data to be transmitted from the sender data processing system exceeds a flow size threshold;
dividing, responsive to the amount of data exceeding the flow size threshold, the data into a set of chunks, each chunk in the set of chunks being of a chunk size;
selecting, according to a mapping selection rule, from a set of selected label mappings, a subset of selected label mapping, wherein each label mapping in the subset of selected label mappings maps an original label used in the data to a different virtual label according to the label mapping;
evaluating, at the application, for a first chunk in the set of chunks, whether by routing the first chunk to a first networking component corresponding to a first virtual label from a first label mapping in the subset of selected label mappings, a fraction of the amount of data that will have been routed to the first component will exceed a mapping threshold;
replacing, responsive to the evaluating being affirmative, the original label in first chunk with a second virtual label from a second label mapping in the subset of selected label mappings; and
routing the first chunk to a second networking component corresponding to the second virtual label at the time of the routing.

2. The method of claim 1, further comprising:
evaluating, at the application, for a second chunk in the set of chunks, whether by routing the second chunk to the second networking component, a second fraction of the amount of data that will have been routed to the second component will exceed the mapping threshold;
replacing, responsive to the evaluating being negative, the original label in second chunk with the second virtual label; and
routing the second chunk to the second networking component corresponding to the second virtual label at the time of the routing.

3. The method of claim 1, wherein the original label is usable to transmit the data to a receiver application executing in a receiver data processing system, and wherein the virtual label changeably associated with a networking component in a data network used for transmitting the data during a period in which the transmitting occurs.

4. The method of claim 1, further comprising:
selecting the set of selected label mappings from a set of configured label mappings, wherein the set of configured label mappings comprises a mapping from each original label that can be received at the application in the sender data processing system to a subset of a set of virtual labels.

5. The method of claim 1, further comprising:
selecting the chunk size according to a value configured in a chunk size parameter.

6. The method of claim 1, further comprising:
selecting the chunk size according to a value configured in a chunk time parameter, wherein the chunk size corresponds to an amount of data received at the application for transmission during a period equal to the value of the chunk time parameter.

7. The method of claim 1, further comprising:
selecting the chunk size according to a value configured in a flowlet parameter, wherein the chunk size corresponds to an amount of data received at the application for transmission during a number of transmission bursts equal to the value of the flowlet parameter.

8. A computer usable program product comprising a computer readable storage device including computer usable code for host-based load balancing of network traffic, the computer usable code comprising:
computer usable code for determining, at an application executing at a sender data processing system, whether an amount of data to be transmitted from the sender data processing system exceeds a flow size threshold;
computer usable code for dividing, responsive to the amount of data exceeding the flow size threshold, the data into a set of chunks, each chunk in the set of chunks being of a chunk size;
computer usable code for selecting, according to a mapping selection rule, from a set of selected label mappings, a subset of selected label mapping, wherein each label mapping in the subset of selected label mappings maps an original label used in the data to a different virtual label according to the label mapping;
computer usable code for evaluating, at the application, for a first chunk in the set of chunks, whether by routing the first chunk to a first networking component corresponding to a first virtual label from a first label mapping in the subset of selected label mappings, a fraction of the amount of data that will have been routed to the first component will exceed a mapping threshold;
computer usable code for replacing, responsive to the evaluating being affirmative, the original label in first chunk with a second virtual label from a second label mapping in the subset of selected label mappings; and
computer usable code for routing the first chunk to a second networking component corresponding to the second virtual label at the time of the routing.

9. The computer usable program product of claim 8, further comprising:
computer usable code for evaluating, at the application, for a second chunk in the set of chunks, whether by routing the second chunk to the second networking component, a second fraction of the amount of data that will have been routed to the second component will exceed the mapping threshold;
computer usable code for replacing, responsive to the evaluating being negative, the original label in second chunk with the second virtual label; and
computer usable code for routing the second chunk to the second networking component corresponding to the second virtual label at the time of the routing.

10. The computer usable program product of claim 8, wherein the original label is usable to transmit the data to a receiver application executing in a receiver data processing system, and wherein the virtual label changeably associated with a networking component in a data network used for transmitting the data during a period in which the transmitting occurs.

11. The computer usable program product of claim 8, further comprising:
computer usable code for selecting the set of selected label mappings from a set of configured label mappings, wherein the set of configured label mappings comprises a mapping from each original label that can be received at the application in the sender data processing system to a subset of a set of virtual labels.

12. The computer usable program product of claim 8, further comprising:
computer usable code for selecting the chunk size according to a value configured in a chunk size parameter.

13. The computer usable program product of claim 8, further comprising:
computer usable code for selecting the chunk size according to a value configured in a chunk time parameter, wherein the chunk size corresponds to an amount of data received at the application for transmission during a period equal to the value of the chunk time parameter.

14. The computer usable program product of claim 8, further comprising:
computer usable code for selecting the chunk size according to a value configured in a flowlet parameter, wherein the chunk size corresponds to an amount of data received at the application for transmission during a number of transmission bursts equal to the value of the flowlet parameter.

15. The computer usable program product of claim 8, wherein the computer usable code is stored in a computer readable storage device in a data processing system, and wherein the computer usable code is transferred over a network from a remote data processing system.

16. The computer usable program product of claim 8, wherein the computer usable code is stored in a computer readable storage device in a server data processing system, and wherein the computer usable code is downloaded over a network to a remote data processing system for use in a computer readable storage device associated with the remote data processing system.

17. A data processing system for host-based load balancing of network traffic, the data processing system comprising:
a storage device, wherein the storage device stores computer usable program code; and
a processor, wherein the processor executes the computer usable program code, and wherein the computer usable program code comprises:
computer usable code for determining, at an application executing at a sender data processing system, whether an amount of data to be transmitted from the sender data processing system exceeds a flow size threshold;
computer usable code for dividing, responsive to the amount of data exceeding the flow size threshold, the data into a set of chunks, each chunk in the set of chunks being of a chunk size;
computer usable code for selecting, according to a mapping selection rule, from a set of selected label mappings, a subset of selected label mapping, wherein each label mapping in the subset of selected label mappings maps an original label used in the data to a different virtual label according to the label mapping;
computer usable code for evaluating, at the application, for a first chunk in the set of chunks, whether by routing the first chunk to a first networking component corresponding to a first virtual label from a first label mapping in the subset of selected label mappings, a fraction of the amount of data that will have been routed to the first component will exceed a mapping threshold;
computer usable code for replacing, responsive to the evaluating being affirmative, the original label in first chunk with a second virtual label from a second label mapping in the subset of selected label mappings; and
computer usable code for routing the first chunk to a second networking component corresponding to the second virtual label at the time of the routing.

18. The data processing system of claim 17, further comprising:
computer usable code for evaluating, at the application, for a second chunk in the set of chunks, whether by routing the second chunk to the second networking component, a second fraction of the amount of data that will have been routed to the second component will exceed the mapping threshold;
computer usable code for replacing, responsive to the evaluating being negative, the original label in second chunk with the second virtual label; and
computer usable code for routing the second chunk to the second networking component corresponding to the second virtual label at the time of the routing.

19. The data processing system of claim 17, wherein the original label is usable to transmit the data to a receiver application executing in a receiver data processing system, and wherein the virtual label changeably associated with a networking component in a data network used for transmitting the data during a period in which the transmitting occurs.

20. The data processing system of claim 17, further comprising:
computer usable code for selecting the set of selected label mappings from a set of configured label mappings, wherein the set of configured label mappings comprises a mapping from each original label that can be received at the application in the sender data processing system to a subset of a set of virtual labels.
